(19) United States
(12) Patent Application Publication
(10) Pub. No.: US 2011/0088307 A1
(43) Pub. Date: Apr. 21, 2011

(54) ANIMATED BIRD DECOY AND ASSOCIATED METHODS

(76) Inventor: Jason Todd Rice, Layton, UT (US)

(21) Appl. No.: 12/908,577

(22) Filed: Oct. 20, 2010

Related U.S. Application Data
(60) Provisional application No. 61/253,152, filed on Oct. 20, 2009.

(51) Int. Cl. A01M 31/06

(52) U.S. Cl. 43/3

(57) ABSTRACT

A bird decoy comprises a body and at least two appendages extending from the body. The appendages can be shaped to approximate an appearance of a wing of a bird. Each appendage can have at least two distinct moveable members, each of which is independently controllable relative to the other. An associated method of luring a live bird to a predetermined location comprises positioning the bird decoy in the vicinity of the predetermined location. The method further includes independently acting, in one or more defined sequences, movement of the body and movement of the at least two appendage to replicate the appearance of a live bird.

### PRIORITY CLAIM

Priority is claimed to copending U.S. Provisional Patent Application Ser. No. 61/253,152, filed Oct. 20, 2009, which is hereby incorporated herein in its entirety.

### FIELD OF THE INVENTION

The present invention relates to animated bird decoys and methods of luring live birds to pre-determined locations.

### BACKGROUND OF THE INVENTION AND RELATED ART

A variety of decoys have been used throughout history to attract animals, namely birds, for the purposes of hunting, observing or researching birds such as geese, ducks, turkeys and others. Some bird decoys can be used to repel certain types of birds that are considered pests. Regardless of the purpose for which it is used, the ultimate goal of a bird decoy is to imitate the appearance and even emulate the behavior of certain birds.

Many decoys are static or motionless while others comprise moving parts that are configured to simulate a particular type of bird's motion. For example, some decoys include wings that flap up and down. Further, some decoys include wings that flap forward and backward, such as the decoy disclosed in U.S. Patent Publication No. 2005/0144828. Other decoys comprise a tilting mechanism, which allow the body of the bird decoy to tilt between a substantially upright position and a forward-leaning position, such as that disclosed in US U.S. Pat. No. 5,036,614.

While decoys having moving parts can be more effective at attracting a bird of interest than motionless decoys, current decoys with moving parts generally fail to accurately mimic the natural movements of a live bird. This can be problematic because live birds can often recognize artificial movements and thus they are repelled rather than attracted to the decoy.

Accordingly, decoys capable of mimicking the natural movements of live birds are continually being sought.

### SUMMARY

The present invention provides an animated bird decoy, and a method of luring a live bird to a pre-determine location. In one embodiment, the method of luring a live bird can include positioning an animated bird decoy in the vicinity of the pre-determined location. In one aspect, the animated decoy may be configured to replicate the movement of a live goose. The decoy can include a body having a cavity formed therein. At least two appendages can extend from the body. The appendages can both be shaped to approximate the appearance of a wing of bird. Also, each appendage can have at least two distinct moveable members, which can be independently controllable relative to the other. The method luring a live bird to a pre-determined location can also include independently actuating, in a first defined sequence, movement of the body and movement of the at least two members of the at least two appendages to replicate the appearance of the live bird.

In another aspect, the present invention provides a method of replicating movement of a live goose. The method can include coordinating at least three distinct aspects of motion associated with an animated goose decoy. The three distinct aspects of motion can include movement at a first joint positioned between a body of the decoy and an appendage extending from the body. The appendage can include at least two distinct moveable members, and can further be shaped to approximate an appearance of a wing of a goose. Another aspect of motion may include movement at a second joint positioned between the at least two distinct moveable members of the appendage. Still yet another aspect of motion can include movement at a third joint positioned between the body and a base associated with and providing support to the body.

There has thus been outlined, rather broadly, some important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a perspective, side view of a goose decoy in accordance with one embodiment of the present invention, wherein the appendages that extend from the body of the decoy are in a folded position.

FIG. 2 is a perspective, front view of the goose decoy of FIG. 1, wherein the appendages that extend from the body are in an opened or unfolded position, and wherein the body of the goose decoy is tilted downward such that it is in a substantially horizontal position.

FIG. 3 is a perspective, rear view of the goose decoy of FIG. 1, wherein the appendages that extend from the body are in an opened or unfolded position.

FIG. 4 is a perspective, side view of the goose decoy of FIG. 1, wherein the appendages that extend from the body are in an opened or unfolded position, and the body is tilted upward in a more vertical orientation.

FIG. 5 illustrates a pivot assembly associated with the animated bird decoy in accordance with one embodiment of the invention.

FIG. 6 is a close-up view of the pivot assembly of FIG. 5, showing the servo motor and the intermeshing gears.

FIG. 7 illustrates an enclosure (shown in an open position) associated with the bird decoy and having a motion control circuit board and receiver enclosed therein.

FIG. 8 illustrates the enclosure of FIG. 7 in a closed position, and having servo motor connection wires and a power connection wire extending therefrom.

FIG. 9 is an exemplary embodiment of a remote control system for use with one embodiment of the bird decoy. More specifically, FIG. 9 illustrates various types of transmitters and a receiver that may be used in connection with the bird decoy.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

In describing and claiming the present invention, the following terminology will be used:

The singular forms “a,” “an,” and “the” can include plural referents unless the context clearly dictates otherwise.

As used herein, the term “independently controllable” is to be understood to indicate that a certain element or component is capable of being set into motion without necessarily setting other elements or components into motion. For example, a first member of an appendage extending from the body of the decoy may be actuated or set into motion without actuating and setting into motion a second member of the appendage, even if both the first and second members are coupled to one another.

In some embodiments of the invention, one element or component, when actuated or controlled, may cause another element or component to physically move, but will not cause the other element or component to be actuated or moved in a predetermined path or pattern that the other element takes when emulating the movement of a bird. For example, in some embodiments of the invention, at least three components of the decoy can be independently actuated in a pattern of emulation: a tilting mechanism associated with a body of the decoy and a base of the decoy, a first wing component nearest a body of the decoy, and a second wing component extending from the first wing component. When it is stated herein that the base or titling mechanism is independently controllable relative to the second wing component, it is understood that actuating the base or titling mechanism causes the second wing component to physically move (as it is attached to the body which is being moved by actuation of the base). However, for purposes of this disclosure, this movement of the second wing component is specifically excluded from the definition of actuating the second wing component. In other words, merely moving a first component by way of actuating another component does not mean that the first component has been actuated.

As used herein, the terms “remote control” or “remotely control” can be used as verbs and can refer to the ability to control the movement of and actuate the moveable components of the bird decoy without any physical contact with the decoy or the components thereof For example, a user positioned several feet away from the decoy may remotely control movement of the decoy without direct or indirect physical contact with the decoy. The term “remote control” may also be used as a noun to describe a device which is associated with, but not directly or indirectly coupled to the decoy and which is configured to control movement of the decoy from a distance away from the decoy. For example, a user positioned about thirty (30) feet away from the decoy may use a remote control to set the bird decoy in motion.

As used herein, the term “pre-determined location” refers to any geographic location selected by a user of the bird decoy. For example, a hunter might place the bird decoy within a pre-determined location comprising several acres of land so that live birds will be attracted to such land. In one aspect, the pre-determined location can comprise a geographic locality, substantially all of which is within shooting range of the position of the hunter.

As used herein, the term “animated” is used to denote an inanimate object having life-like qualities. For example, an inanimate goose decoy may be animated to imitate the movement of a live goose.

Reference is consistently made herein to use of the present invention with geese. It is to be understood, however, that the invention can be readily adapted for use with a variety of fowl, such as ducks.

With these definitions in mind, reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. Further, it is noted that the figures are not necessarily drawn to scale, but rather may be drawn to more clearly show embodiments of the present invention.

In one embodiment, the present invention is drawn generally to an animated bird decoy. In another embodiment, the present invention is generally drawn to a method of luring a live goose to a pre-determined location and a method of replicating movement of a live goose. Various details are provided herein which are applicable to the animated bird decoy and both associated methods of luring a live goose and replicating movement of live goose.

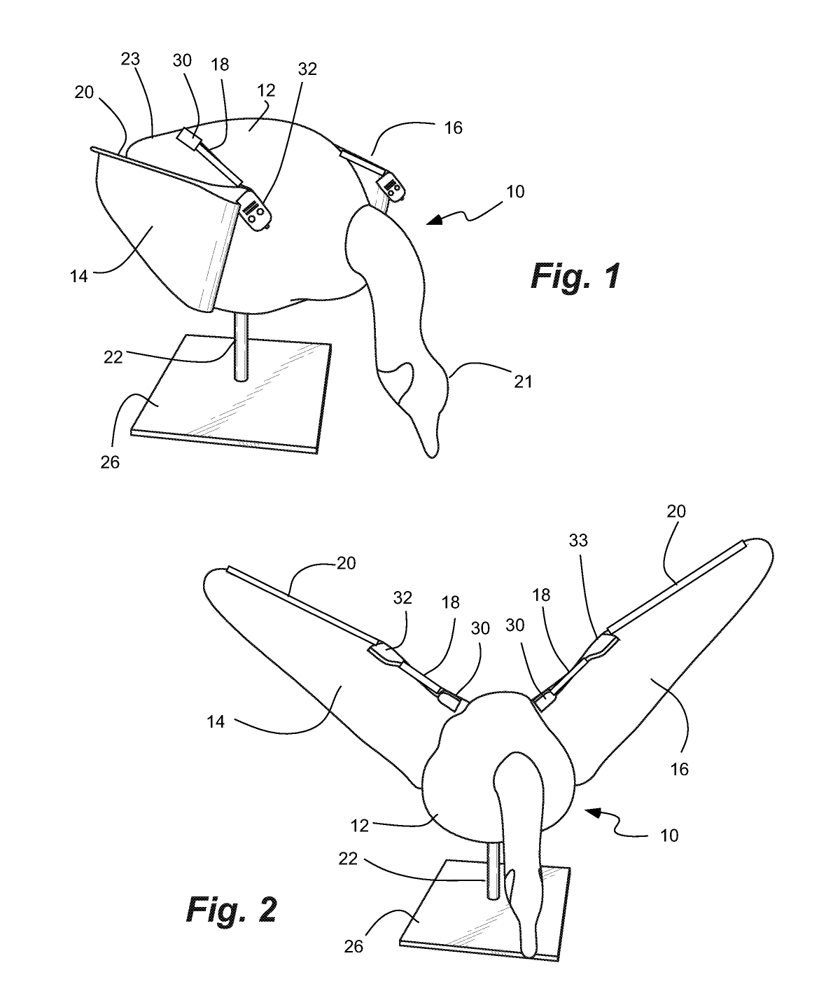

Turning now to the figures, the invention will be described referring to FIGS. 1-9. The same elements are assigned the same numerals throughout the Figures so that repeated description can be avoided.

As illustrated in FIGS. 1-4, the bird decoy 10 of the present invention can be configured to resemble a live bird and can further be configured to replicate the natural movements of a live bird. Examples of the types of natural movements that may be imitated include mating and feeding movements. Other types of movements that may be replicated include landing from flight and preparing to take off for flight. In an exemplary embodiment, the animated decoy 10 can be a goose decoy placed in a pre-determined geographic location for the purpose of attracting live geese. A user of the goose decoy may desire to attract geese to the pre-determined location for the purposes of hunting, photographing, researching or investigating the behaviors of live geese.

The embodiment shown in FIGS. 1-4, provides an animated goose decoy 10 in accordance with one aspect of the present invention. As shown, the animated decoy can include a body 12 having a cavity therein, and at least two appendages 14, 16 extending from the body. In one embodiment, the body of the decoy can be formed of a rigid, lightweight, and durable material, such as a polyethylene plastic. Polyethylene is known to be able to withstand extreme cold temperatures without cracking or becoming brittle. Materials other than plastic may also be used in some embodiments. Preferably, the body can be configured to withstand extreme weather conditions since the decoy will likely be used in a variety of weather conditions including windy, wet, cold, icy, sunny, snowy, and so forth. The material forming the body should have a strength and thickness sufficient to support the appendages 14, 16 and any other components associated with or coupled to the body. The body may be shaped and sized similar to that of the type of live goose that a user desires to attract. The body can be formed by injection molding, blow molding or any other manufacturing process known in the art. In a further aspect, the body can have openings (not shown) formed therein so that a user can access the inside of the body. Such openings may be placed in a lower portion of the body where such openings are not visible to a live bird. The openings can also be covered in order to disguise their appearance. As described herein, many of the components associated with the decoy may be positioned and/stored within the substantially hollow cavity of the body.

The appendages 14, 16 extending from the body 12 can be shaped to approximate the appearance of wings of a bird. In one embodiment, each appendage may comprise at least two distinct moveable members 18, 20. The moveable members can be configured to resemble the bones, skeleton or framework of a bird's wing. Each moveable member may be independently controllable relative to the other moveable member. Thus, for example, the moveable member 18 proximate to the body can remain stationary while the distal moveable member 20 is moving, and vice versa. Alternatively, both the proximate and distal moveable members can move simultaneously or in a predetermined sequence or pattern.

According to one aspect, as shown in FIG. 1, the at least two appendages 14, 16 can be foldable so as to reflect the appearance of a live goose having its wings in a closed position. In this folded position, the first or proximate moveable member 18 can extend from its point of contact with the body toward the head of the body 12. The second or distal moveable member 20 can extend from an end of the proximate moveable member toward the rear 23 of the body.

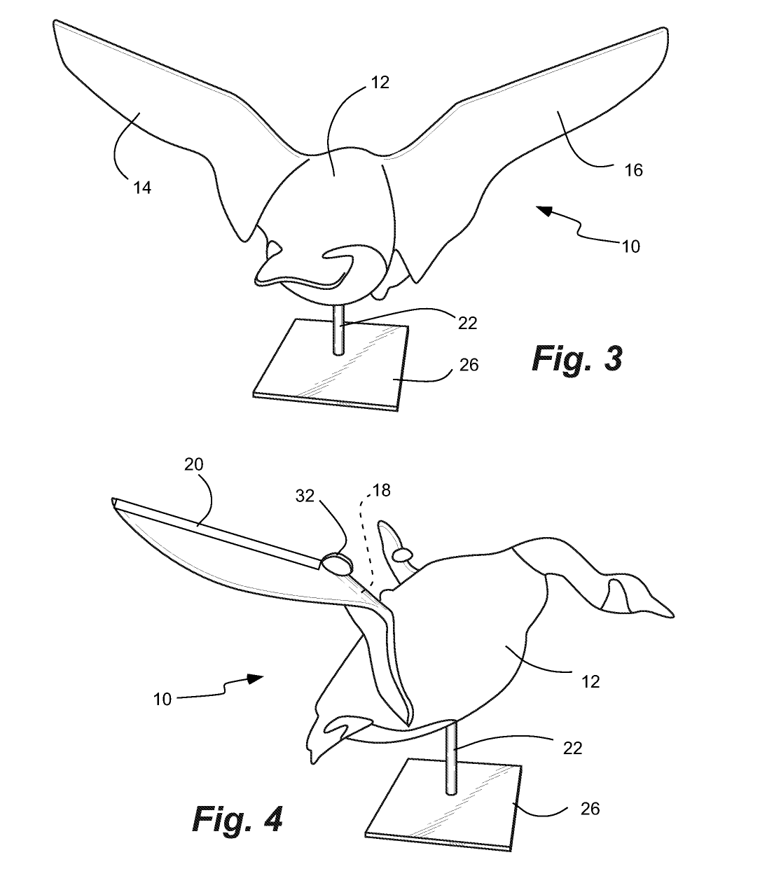

In another aspect, as shown in FIGS. 2 and 3, the at least two appendages 14, 16 can be unfolded so as to reflect the appearance of a live goose having its wings in a substantially opened or fully extended position. FIG. 2 shows a front view of the goose decoy 10 having its wings in an open position and FIG. 3 shows a rear view of the goose decoy having its wings in an open position. In this open or unfolded position, the proximate and distal moveable members 18, 20 form a substantially straight line that extends to a large extent perpendicular to the body. Notably, the appendages 14, 16 can pass through or be held in various positions between substantially completely folded and fully extended positions.

In a preferred aspect, the at least two appendages 14, 16 can be moveably coupled to the body 12. By way of example, an end of the proximate members 20 of each appendage may be moveably coupled to the body at locations on either side of the body so as to form shoulder joints 30, 31 as shown in FIG. 2. The shoulder joints can sit in one of a variety of optional positions. In one example, the shoulder joint can sit within a bracket (not shown) that is at least partially recessed into the body of the decoy. Alternatively, the joint can sit within a bracket positioned directly on the body. In still yet a further aspect, the joint can sit within a bracket positioned slightly away from and not directly in contact with the body. The position of the bracket and joint can affect the look of the motion at the shoulder joint. In some instances, the movement may look more natural and more closely mimic the movement of a live goose when the joint is positioned within a bracket that is at least partially recessed into the body of the decoy 10.

In one embodiment, as shown in FIG. 2, the proximate and distal moveable members 18, 20 of each appendage 14, 16 may be moveably coupled to each other in order to form elbow joints 32, 33. With respect to both the elbow and shoulder joints 30, 31, a variety of types of joints known in the art may be used to provide a point about which the respective members can move. By way of example, and not by way of limitation, the shoulder and elbow joints can incorporate a ball joint, heim joint, or any number of pivot joints, all of which are well known by those having ordinary skill in the art.

In order to provide motion at the elbow joints 32, 33, an actuator (not shown) can be associated with the joints, and positioned at or near the elbow joints, substantially between the two distinct members 18, 20. Likewise, in order to provide motion at the shoulder joints 30, 31 an actuator (not shown) can be associated with and positioned near or at the joint, substantially between the body 12 and the member 18 of the appendage that is proximate to the body. The actuators may have servomechanisms or servomotors (not shown) associated therewith in order to provide position control with respect to the individual members of the appendage. Servomotors are well-known in the art. In one aspect, the servomotors of the present invention can be electronic in nature, and thereby use an electric motor to create the mechanical force. In another aspect, the servomotors of the present invention can be RC servos, also know as radio control servos, which are commonly used to provide actuation for mechanical systems. Typically, RC servos include an electric motor, position feedback potentiometer, reduction gear and actuating arm.

In one aspect, the bird decoy 10 of the present invention can be configured for placement on water. Accordingly, the decoy and its components may be waterproof Further, the body can be configured to float atop water.

As shown in FIGS. 1-4, the bird decoy can include a support 22 upon which the body 12 of the decoy 10 can be positioned above a ground surface. The support can be removably coupled to a base 26. In one aspect, the base can have a size, weight and shape sufficient to stabilize the body in a substantially upright orientation throughout a series of motions of the at least two appendages 14, 16. In another aspect, the base can be relatively lightweight such that it can be easily carried and transported by a user. In still yet a further aspect, the base can be hollow and lightweight, making it easy to transport. Once placed in its desired location, the base may be filled with water, sand or some other substance to increase the weight and stability of the base. In another aspect, the base can comprise an opening (not shown) to allow access so that a user can store or place other components associated with the decoy, such as a battery to provide power to the decoy. Similarly, the surface of the base can be recessed in certain locations to allow for storage or placement of other components associated with the decoy.

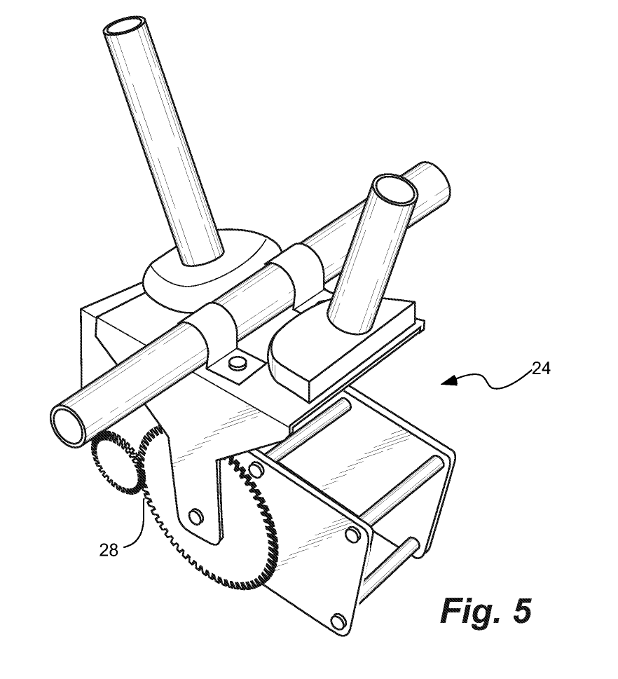

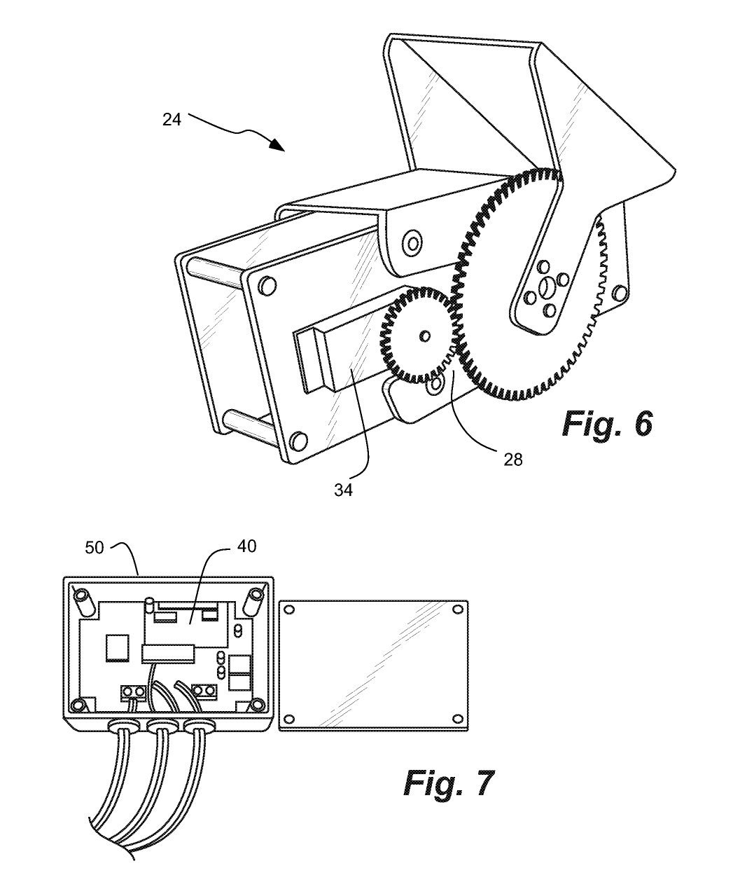

Referring now to FIGS. 5 and 6, according to one aspect, the decoy of the present invention can have a pivot mechanism 24 or pivot assembly associated with the support and the body. The pivot mechanism can be configured to provide a range of motion of the body between a substantially horizontal position and a more vertical position with respect to a ground surface. FIGS. 1, 2, and 3 show the body 12 in a substantially horizontal position, while FIG. 4 shows the body in a substantially vertical position. In a further aspect, the pivot mechanism 24 can be independently controllable relative to the at least two distinct members of the appendages. Thus, in use, a user can actuate the pivot assembly without actuating the appendages and vice versa. Alternatively, the appendages may be actuated without actuating the pivot mechanism. In still yet a further aspect, the pivot mechanism may be actuated simultaneously with one or both of the distinct members of the appendages.

The pivot mechanism 24, as shown in FIGS. 5 and 6, can be configured for placement substantially within the cavity of body. Alternatively, the pivot mechanism may be configured for placement outside of or at least partially outside of the body.

As best illustrated in FIG. 6, the pivot mechanism 24 can include intermeshing gears 28, which can be set into motion by an actuator 34. The actuator can be associated with the body and the support, and can be positioned between the body and the support. In a further aspect, the actuator can comprise a servomotor (not shown) or servomechanism, which is well-known in the art. The servomotor can be similar to or the same as the servomotors described herein with respect to the joints associated with the members of the appendages. In use, the servomotor can set at least one of the gears into motion, thereby also indirectly actuating one or more additional gears.

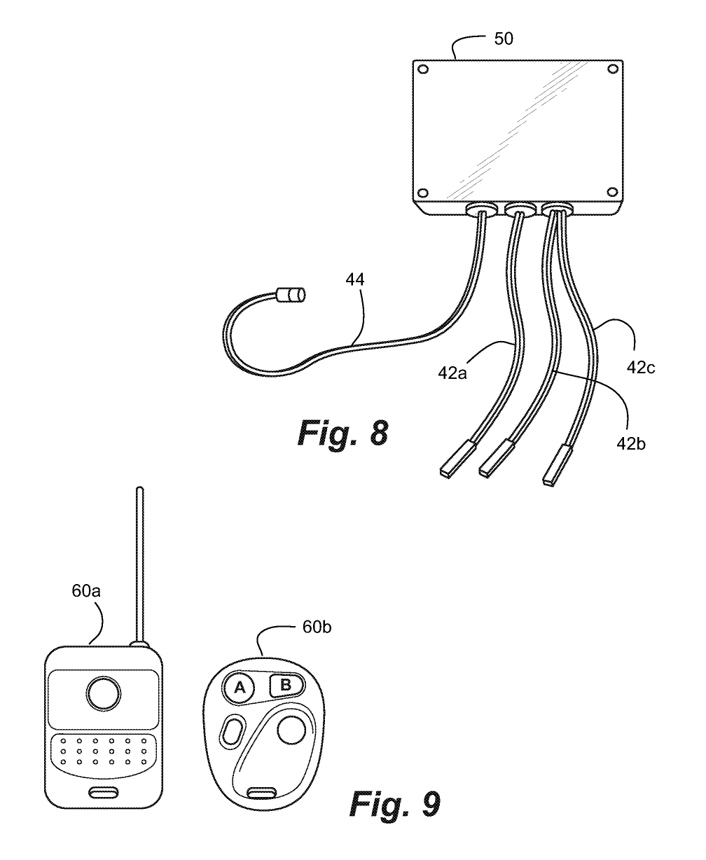

Referring now to FIGS. 7 and 8, the bird decoy may include a circuit board 40 associated with the decoy. As shown, the circuit board can be stored within a container or box 50 that can be positioned within the hollow cavity of the body. In one aspect, the circuit board can be programmed to coordinate operation of multiple actuators associated with the decoy. For example, the circuit board may be configured to coordinate operation of first and second actuators positioned near the shoulder and elbow joints of the appendages. The circuit board may further be configured to coordinate operation of a third actuator associated with the pivot mechanism. In practice, multiple distinct aspects of motion associated with the goose decoy may be coordinated via the circuit board.

In an exemplary embodiment, three distinct aspects of motion may be coordinated via the circuit board. More specifically, and as shown in FIG. 8, the circuit board can communicate with one or more actuators via a plurality of wires 42a, 42b, 42c extending from the circuit board and connecting the circuit board to the individual actuators. For example, a first aspect of motion can include movement at the shoulder joint or, in other words, the joint positioned between a body of the decoy and an appendage extending from the body. A second aspect of motion can include movement at a second joint; this joint being positioned between the at least two distinct moveable members of the appendage. A third aspect of motion can include movement at a third joint positioned between the body and the base. This coordination or pattern of emulation of the distinct aspects of motion can serve to very closely replicate or imitate the motion of a live bird, e.g., a goose, such that it becomes difficult to distinguish between the decoy and a live goose.

In another embodiment, the circuit board can be programmed to independently actuate, in a first defined sequence, movement of the body and movement of the at least two members associated with each of the appendages in order to replicate the appearance of the live bird. In addition, the circuit board can be programmed to repeat the defined sequence with or without additional input from the user. Similarly, in another aspect, the decoy can repeat a series of different sequences of movement. Thus, by way of example, a first sequence can comprise actuation of the tilt or pivot mechanism followed by a series of actuation of the elbow and shoulder joints. A second sequence can comprise actuation of pivot mechanism only such that the goose decoy leans forward and then back and forward and back again. A third sequence can include actuation of only the joints associated with each appendage such that it appears that the decoy is performing a series of flapping motions and half flapping motions.

The first, second and third sequences may be combined to actuate movement of the decoy for an extended period of time with a single prompt from a user. Any number of sequences of motions may be programmed and recorded based on the natural bird movements sought to be replicated. Once the decoy has run the full program of sequences, the program can be repeated. In one aspect, the sequences of motion can be programmed by the manufacturer prior to retailing or distributing the decoy to consumers. In another aspect, the consumer or end user can be provided with access and ability to create personalized programs and sequences of motions.

Still referring to FIG. 8, one or more power sources (not shown) may be used in connection with the decoy of the present invention. Power sources are well-known in the art and a variety of types of known power source may be used in connection with the present animated decoy. In one aspect, the power source may be one or more batteries. For example, a single battery can be used for processing and logic associated with the circuit board, while another battery may be used to power the servomechanisms. FIG. 8 shows a power wire 44 extending from the circuit board container, which can connect to a power source. For ease of use, a battery can be stored within the hollow cavity of the body or in battery trays or recesses associated with the base of the decoy.

In still yet a further aspect, the bird decoy of the present invention can comprise a transmitter and receiver combination to enable a user to remotely control movement of the decoy. As such, movement of the at least two appendages and pivot mechanism can be remotely actuated from a distance away from the bird decoy. Transmitters and receivers are well-known by those having ordinary skill in the art. Transmitters generally refer to an electronic device which can promulgate an electromagnetic signal such as a radio or other telecommunication signal. Receivers generally refer to electronic circuits that receive input from a transmitter via an antenna associated with the receiver.

In one aspect a remote receiver can be associated directly with the body of the decoy. For example, the receiver may be housed, together with the circuit board, within an enclosure, such as a box, configured to be stored within the hollow cavity of the body. FIG. 8 shows the enclosure or box of FIG. 7 in a closed position and having the wiring for connection to the servomechanisms and power supply extending therefrom. The transmitter can be kept within the possession of the user so that a user can transmit a signal to the receiver associated with the decoy, thereby initiating or terminating the program which controls movement of the decoy. FIG. 9 shows examples of transmitters and receivers 60a, 60b that may be used in connection with the decoy of the present invention.

Referring now to the appearance and ornamental features of the decoy, the body of the decoy may be hand or machine painted to imitate elaborate feather details. To further imitate feather details, the surface of the body may be textured rather than smooth, although this is not required. The appendages can comprise features resembling those of the wings of a bird. For example, the appendages may comprise a non-rigid, flexible fabric having a feather-like pattern printed thereon. In one aspect the fabric may comprise nylon. Other fabrics capable of withstanding outdoor elements may also be used. Real or synthetic feathers may also be incorporated into the appendages to further give the appearance of a live bird. Similarly, wings of a real bird may be incorporated and used in connection with the appendages.

Other elements and components may be incorporated into the present decoy to give a more life-like, natural appearance. In one embodiment, two supports may be used in connection with the decoy in order to achieve the appearance of legs extending downward from the body. In another embodiment, one support may be purely cosmetic in nature while the other provides utility in connection with the pivot mechanism.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. An animated bird decoy comprising:
a body;
at least two appendages shaped to approximate an appearance of a wing of a bird and extending from the body, each appendage comprising at least two distinct moveable members;
wherein each of the at least two moveable members is independently controllable relative to the other.

2. The bird decoy of claim 1, wherein the body includes a cavity formed therein.

3. The bird decoy of claim 1, wherein the at least two appendages are foldable.

4. The bird decoy of claim 1, further comprising a support on which the body can be positioned above a ground surface, and further comprising a pivot mechanism associated with the support and the body, the pivot mechanism configured to provide a range of motion of the body between a substantially horizontal position and a more vertical position.

5. The bird decoy of claim 4, wherein the support is removably coupled to a base, the base having a weight sufficient to stabilize the body in a substantially upright orientation throughout a series of motions of the at least two appendages.

6. The bird decoy of claim 4, wherein the pivot mechanism is independently controllable relative to the at least two moveable members.

7. The bird decoy of claim 4, wherein the pivot mechanism includes intermeshing gears.

8. The bird decoy of claim 1, wherein the at least two appendages are moveably coupled to the body.

9. The bird decoy of claim 1, wherein the at least two members of each appendage are moveably coupled to each other.

10. The bird decoy of claim 1, further comprising:
a first actuator positioned between the body and one of the at least two appendages; and
a second actuator positioned between the at least two members.

11. The bird decoy of claim 10, wherein the first and second actuators comprise servomotors.

12. The bird decoy of claim 10, further comprising a third actuator between the body and a support on which the body can be positioned above a ground surface.

13. The bird decoy of claim 12, wherein the third actuator comprises a servomotor.

14. The bird decoy of claim 10, further comprising a circuit board associated with the decoy, wherein the circuit board is programmed to coordinate operation of the first and second actuators.

15. The bird decoy of claim 10, further comprising a third actuator associated with a pivot mechanism, wherein the pivot mechanism is configured to provide a range of motion of the body between a substantially horizontal position and a more vertical position.

16. The bird decoy of claim 1, further comprising a power source associated with the decoy.

17. The bird decoy of claim 1, further comprising;
a transmitter associated with the decoy; and
a receiver associated with the decoy.

18. The bird decoy of claim 1, wherein movement of the at least two appendages is remotely actuated from a distance away from the bird decoy.

19. A method of luring a live bird to a pre-determined location comprising:
positioning a bird decoy in the vicinity of the pre-determined location, the bird decoy comprising:
a body having a cavity formed therein;
at least two appendages shaped to approximate an appearance of a wing of a bird and extending from the body, each appendage comprising at least two distinct moveable members;
wherein each of the at least two moveable members is independently controllable relative to the other; and
independently actuating, in a first defined sequence, movement of the body and movement of the at least two members of the at least two appendages to replicate the appearance of the live bird.

20. The method of claim 19, further comprising repeating the defined sequence.

21. A method of replicating movement of a live goose comprising;
coordinating at least three distinct aspects of motion associated with a goose decoy, the at least three distinct aspects of motion comprising:
movement at a first joint positioned between a body of the decoy and an appendage extending from the body, the appendage being shaped to approximate an appearance of a wing of a goose, and comprising at least two distinct moveable members;
movement at a second joint positioned between the at least two distinct moveable members of the appendage; and
movement at a third joint positioned between the body and a base associated with and providing support to the body.

22. The method of claim 21, wherein the base has a weight and shape sufficient to maintain the body in a substantially upright orientation during movement of the at least three distinct aspects of motion.
